(19) United States
(12) Patent Application Publication
(10) Pub. No.: US 2012/0208071 A1
(43) Pub. Date: Aug. 16, 2012

(54) Method of Producing Thin Batteries

(75) Inventor: Shoujun Li, Espoo (FI)

(73) Assignee: ENFUCELL LTD, Vantaa (FI)

(21) Appl. No.: 13/379,856

(22) PCT Filed: Jun. 21, 2010
(86) PCT No.: PCT/FI2010/050525

§ 371 Date: May 3, 2012

(30) Foreign Application Priority Data
Jun. 26, 2009 (FI) 20095728

(51) Int. Cl. H01M 10/04; H01M 6/02; H01M 6/40

(52) U.S. Cl. 429/162; 29/623.3; 29/730

(57) ABSTRACT

The invention relates to production of thin batteries. In order to achieve a fast and simple production process, the method comprises: bringing into use an anode web comprising anode half cells consisting of multiple material layers applied on top of each other, and which layers are mutually aligned and sized for use in a thin battery, bringing into use a cathode web comprising cathode half cells consisting of multiple material layers applied on top of each other, and which layers are mutually aligned and sized for use in a thin battery, aligning said anode web and said cathode web into a mutual predetermined position, and bringing said anode web and said cathode web into contact with each other in order to attach said anode half cells to corresponding cathode half cells for producing thin batteries.

### CROSS-REFERENCE TO RELATED APPLICATIONS

This application is a National Stage application of International Application No. PCT/FI2010/050525, filed Jun. 21, 2010, which claims benefit to Finnish Application No. 20095728, filed Jun. 26, 2009, which are incorporated by reference herein in its entirety.

### BACKGROUND

1. Field

The present invention relates to production of thin batteries, in other words thin and flexible batteries that may be bent to some extent without affecting the performance of the batteries.

2. Description of the Related Art

A thin battery involves a plurality of material layers arranged on top of each other such that the layers are mutually aligned into predetermined positions. In order to avoid electrical short-cuts within the thin battery from one layer to another layer, it is important that the layers of the battery are arranged in the intended positions. Other reasons for mutually aligning the material layers into predetermined and intended positions are to guarantee the uniformity of battery performance and to guarantee a uniform outlook of the thin batteries.

Previously there exists a production method for thin batteries where layers of the battery are cut into predetermined shapes and sizes. After the cutting stage the cut pieces are placed in desired positions within the thin battery and the layers of the battery are attached to each other.

Some problems exist with the above-mentioned production method and therefore the current production process is complicated and slow.

A first problem is that the mutual alignment of the layers in desired positions is difficult. In practice, the size of the pieces to be aligned and assembled is small and it is difficult to get the pieces in the correct positions within the battery.

A second problem is how to cost effectively and accurately convey these discrete small pieces to the predetermined position.

Thirdly, as there exists lot of problems in the process of mutually aligning the material layers into predetermined and intended positions the uniformity of battery performance and the uniformity of the outlook of the thin batteries are currently not guaranteed.

### SUMMARY

An object of the present invention is to solve the above-mentioned drawbacks and to provide a method of producing thin batteries which is less complicated and more efficient than prior art solutions. The present invention also relates to a thin battery produced with such a method.

The object of the invention is achieved with the method of independent claim 1, the thin battery of independent claim 12 and the apparatus of independent claim 13.

In the invention, an anode web comprising anode half cells and a cathode web comprising cathode half cells is utilized for the production of thin batteries. These two webs can be aligned and attached to each other in order to produce thin batteries. In addition, both of these webs may be individually prepared by applying material layers on the respective webs in order to prepare the two webs with the respective parts of the thin battery, namely anodes and cathodes of the thin battery, i.e. the anode and cathode half cells. Such preparation makes it possible to avoid a need to align separate pieces with each other, as the necessary layers can be applied directly on the respective webs, and cut into desired shapes later on, while attached to the web. This simplifies the production process and reduces the time needed for producing a single thin battery.

Preferred embodiments of the invention are disclosed in the dependent claims.

### BRIEF DESCRIPTION OF THE DRAWINGS

In the following the present invention will be described in closer detail by way of example and with reference to the attached drawings, in which

FIGS. 1 and 2 illustrate material layers of a thin battery,

FIG. 3 shows an exploded view that illustrates a production method for thin batteries,

FIG. 4 shows a web line illustrating the production of a web with anodes,

FIG. 5 shows a web line illustrating the production of cathode half cells, and

FIG. 6 shows a web line illustrating the process for laminating anodes and cathodes together.

### DETAILED DESCRIPTION

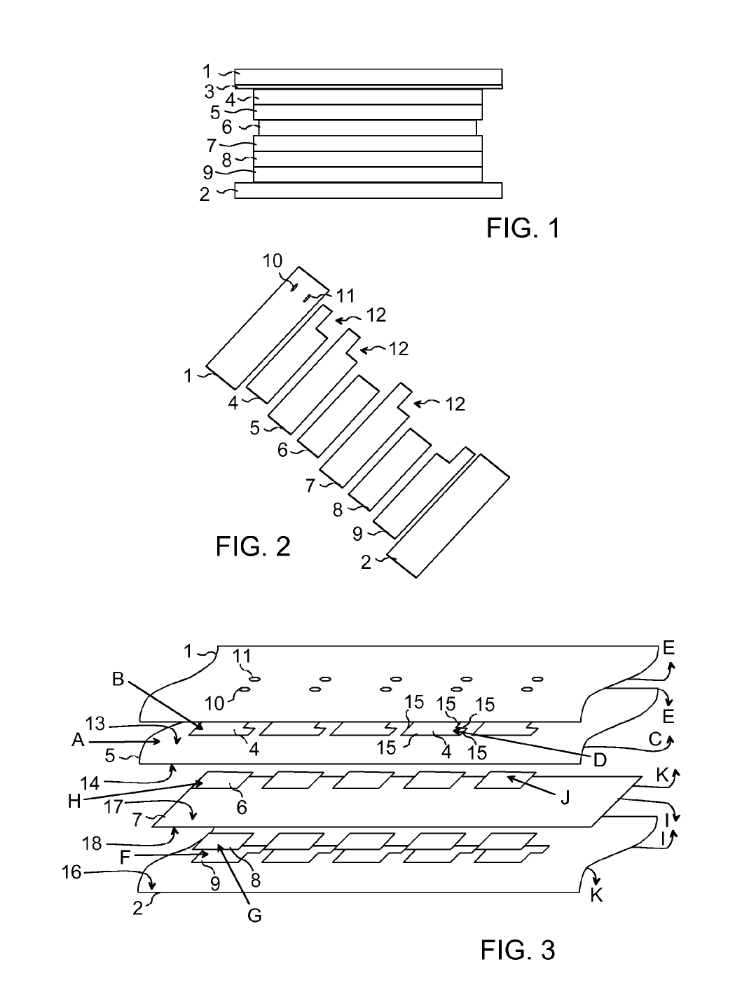

FIGS. 1 and 2 illustrate material layers of a thin battery. These figures are not in scale and the thickness of the layers is not intended to reflect the actual thickness of the material layers. The total thickness of a thin battery is below 3 mm, typically 0.3 to 1.0 mm and more typically 0.6 to 0.8 mm.

### Battery Sealing

In FIGS. 1 and 2 a first cover layer 1 is arranged as the uppermost layer and a second cover layer 2 as the lowest layer. Here it is assumed, by way of example, that the first and second material layers 1 and 2 are the outermost layers of the thin battery, and that these layers are attached to each other with an adhesive layer to protect the interior of the thin battery and to keep the thin battery in one piece. However, naturally additional layers such as application webs can be attached to the thin battery on layer 1 and layer 2. The application webs may convey for example RFID (Radio Frequency Indentifyer) tags or other electronic components e.g. sensors or data loggers.

### Anode and Cathode

The anode material 4 is attached to the first cover layer 1 by the adhesive layer 3 (not shown in FIG. 2). A first separator layer 5 is arranged between the anode material 4 and an electrolytic binder 6. In the figures a second separator layer 7 is arranged under the electrolytic binder 6 and above a cathode material 8. Finally, a cathode collector material 9 is arranged between the second cover material 2 and the cathode material 8.

### Terminals

In order to produce battery terminals, two terminal holes 10 and 11 have been made in the first cover layer 1 and the adhesive layer 3. The first hole 10 is located above the anode material 4, which works as a first battery pole. Due to the cut outs 12 illustrated in layers 4, 5 and 7 of FIG. 2, and due to the smaller size of layers 6 and 8, the second terminal hole 11 is positioned to overlap the cathode collector material 9, which works as a second battery pole.

### The Size of Separators and the Electrolyte Binder

In FIG. 1 it has been shown that either or both of the first 5 and second 7 separator layers are slightly longer/larger, i.e. having a bigger surface area, than the surrounding layers and the electrolyte binder 6 there between, in order to efficiently prevent electric contact between the anode and cathode (sides) of the thin battery. This is, however, not necessary in all embodiments in case the material layers can be mutually aligned into predetermined positions with sufficient accuracy.

FIG. 3 shows an exploded view that illustrates a production method for thin batteries. In the following the production of the anode half cell web will be explained first, though in praxis, it is also possible to start with the production of the cathode half cell web, or to produce both webs at the same time.

The first separator 5 layer can consist of paper or polymer films, for instance, which is unwound from a roll.

In method step A, a first surface 13, which is the upper surface in FIG. 3, is provided with an adhesive release agent (not shown in the figures) which may be varnish, lacquer or silicon or a combination thereof. The adhesive release agent may be applied on the first surface 13 of the first separator layer 5 by printing, coating, spraying or brushing, for instance. The adhesive release agent is arranged to cover substantially the entire first surface 13, except for areas reserved for anodes 4. The adhesive release agent covered areas of the separator 5—later scrap part—function as a release liner.

In method step B anode material 4 is applied on said first side of the first surface 13 of the first separator layer 5, in those areas which are reserved for anodes 4 and not covered with the adhesive release agent. The anode material may consist of anode ink, e.g. containing zinc powder, binder material and carbon, for instance. The anode ink is applied by printing, for instance. After applying the anode material 4, it is allowed to dry.

In method step C the first cover layer 1, which may be a continuous web which is unwound from a roll, is taken into use. The material of this first cover layer 1 may be PP (Polypropylene) or PET (Polyethylene terephthalate) or MPET (Metalized Polyethylene terephthalate), for instance. In that case the interior of the thin battery is efficiently sealed off from the surroundings. The cover layer 1 on said roll may be provided with the adhesive layer 3 (on its lower surface in FIG. 3). Alternatively the adhesive layer 3 may be applied after the first cover layer has been unwound from the roll. The adhesive layer 3 may consist of an acrylic glue or rubber glue, for instance. The cover layer 1 with the adhesive layer 3 is attached to the first separator layer 5, such that the adhesive of the first cover layer 1 attaches to the anode material 4, which is attached to the first separator layer 5. At this stage the adhesive release agent on the first surface 13 of the first separator layer 5 prevents the adhesive layer 3 from being strongly attached to the first separator layer 5 in those areas where the adhesive release agent and the, later scrap part, of the separator layer 5, forming a release liner, is present.

In step D the first separator layer 5 is provided with cuts 15 from the direction of a second side 14 of the first separator layer 5, which is the bottom side of the first separator layer 5 in FIG. 3. The cuts 15 penetrate through the first separator layer 5, and possibly through the adhesive release agent located on the first surface 13 of the first separator layer 5, but not deeper than to the adhesive layer 3. The cuts are arranged to delimit an anode half cell comprising the anode material 4 of one anode. In praxis the cuts 15 are arranged to follow the outer boundaries of the anodes 4.

In step E a scrap part of the first separator layer 5 is removed by pulling this scrap part in a different direction than the first cover layer 1, to which the anode half cells are attached. The removal is easy due to the adhesive release agent which has prevented the adhesive layer 3 from being strongly attached to the first separator layer. The web may be heated before removal of the scrap part to facilitate the removal. In praxis substantially the entire part of the first separator layer 5 to which the adhesive release agent, forming a release liner, has been applied (everything except the delimited anode material 4) is removed in one part.

After step E the web with anode half cells i.e. anodes has been finalized. In case this web is used directly for attaching to a web with cathode half cells, no additional measures are needed. However, in case the attachment to a web with cathode half cells is not done immediately, and instead the web with anode half cells needs to be rewound for intermediate storage, then it is possible to bring the web with anode half cells to contact with a release liner. In that case the release liner will cover the adhesive layer 3 located on the bottom surface of the first cover layer 1 in FIG. 3. Later on once pulled out from the roll, this release liner can be removed such that the adhesive layer 3 is revealed and can be used for attachment to a web with cathode half cells.

In step F the production of the web with cathodes, i.e. cathode half cells is initiated. In this example the second cover layer 2 is taken into use, for instance, by unwinding it from a roll. The material of this second cover layer 2 can be PP (Polypropylene) or PET (Polyethylene terephthalate), for instance. In that case the interior of the thin battery is efficiently sealed off from the surroundings. A first side 16 of the second cover layer 2 is provided with a cathode collector material 9 on areas reserved for cathodes. This first side 16 is turned upwards in FIG. 3 and the areas reserved for cathodes have been provided with the cathode collector material 9 in FIG. 3. The cathode collector material 9 may consist of conductive ink, for example carbon ink or silver ink, or other conductive material, applied by printing, for instance.

In step G cathode material 8 is arranged on said cathode collector material 9. The size and shape of the cathode material 8 is different as compared to the cathode collector material 9 and as shown also in FIG. 3. This is to ensure that the cathode collector material 9 can work as the second pole of the thin battery, as explained in connection with FIG. 1. The cathode material 8 may consist of cathode paste applied by printing, for instance, and containing MnO₂, electrolyte and additives, for instance. Also other types of application methods are possible as explained in connection with the production of anodes.

In step H a second separator layer 7 is taken into use by drawing it from a roll, for instance. The second separator 7 layer may consist of paper, for instance. An electrolytic binder 6 is applied on predetermined binder areas of the first side 17 of the second separator layer 7. In FIG. 3 this first side 17 is turned upwards. The electrolytic binder 6 may contain zinc chloride (ZnCl₂), water, a binder and desired additives, for instance, and it can be applied on the second separator layer by printing, for instance.

In step I the second cover layer 2 and the second separator layer 7 are aligned into predetermined mutual positions and brought into contact with each other such that they are attached to each other by the cathode material 8 in a position where the first side 16 of the second cover 2 layer faces a second side 18 of the second separator layer 7. In FIG. 3 the second side 18 of the second separator layer is turned downwards. Due to the aligning, the cathode material 8 is located in corresponding locations as the electrolytic binder 6 areas, but on an opposite side of the second separator layer 7.

In step J cuts are produced through the second separator layer 7 from the first side 17 of the second separator layer. These cuts are produced to delimit those areas of the second separator layer 7 that were printed with the electrolyte binder 6 in step H. The cuts penetrate through the second separator layer 7 but not substantially deeper than to the second separator layer 7. In this connection the phrase “not substantially deeper” is intended to clarify that no additional layers are penetrated by the cuts, though it is possible to use a cutting tool, for example a plate, that is slightly longer than the thickness of the second separator layer 7.

In step K a scrap part of the second separator layer 7 is removed by pulling it in a different direction than the second cover layer 2. As the cuts have delimited a cathode, i.e. a cathode half cell comprising the cathode collector material 9, the cathode material 8, the electrolytic binder 6 and a part of the second separator layer 7, the scrap part of the separator layer 7 is no longer attached to the produced cathode half cell. After this step the cathode web is ready to be brought into contact with the anode web such that the webs are aligned into a mutual predetermined position.

Inside the thin battery the electrolytic binder 6 of the cathode half cell attaches to the second side (surface 14) of the first separator layer 5 of the anode half cell. In addition, the adhesive layer 3 on the first cover layer 1 attaches to the second cover layer 2 in order to seal off the interior of the thin battery from the surroundings outside of the battery.

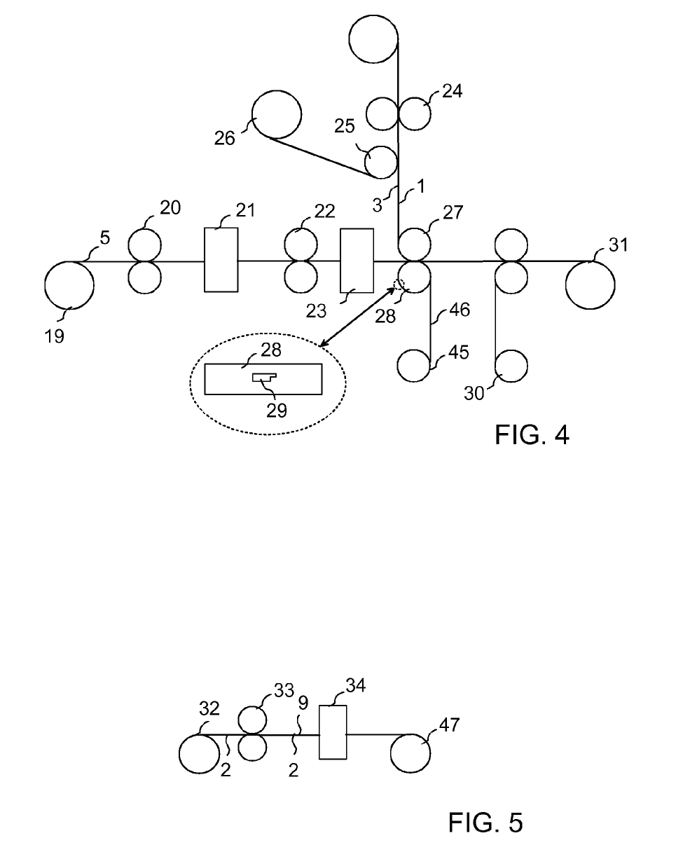

FIG. 4 illustrates production of a web with anodes. The apparatus shown in FIG. 4 can be used for producing anodes with the method as explained in connection with FIG. 3.

The separator layer 5 is unwound from a roll 19 and forwarded to an adhesive release agent printing device 20 that applies an adhesive release agent on the first surface 13 of the first separator layer 5. A dryer 21 is employed in order to dry up the adhesive release agent. It is also possible to use several successive layers of adhesive release agent that layers are respectively successively applied and dryed.

After drying the web is fed to an anode ink printing device 22 which applies anode material 4 on areas of the first separator layer 5, which are reserved for anodes, and on which no adhesive release agent has been printed. A dryer 23 is employed for drying up the anode material 4.

In this example it is assumed that the first cover layer 1 has been provided with the adhesive layer 3 in advance, and in order to be able to store the first cover layer 1 on a roll as a web, a release liner, for instance silicon paper, has been attached to cover the adhesive layer. This web is unwound from the roll and led to a hole punch 24, which punches the terminal holes 10 and 11 into the first cover layer 1 and the adhesive layer 3. After this the release liner is removed with the guiding roll 25 and the release liner is rewound on roll 26 i.e. on a release liner rewinder.

The first cover layer 1 with the adhesive layer 3 and the separator layer 5 with the adhesive release agent are brought together and attached to each other with a laminator 27. The laminator 27 includes a roll 28 with a cutting plate 29 that produces cuts into the separator layer 5 in order to delimit an anode with the cuts. An enlarged front view of the roll 28 and the cutting plate 29 has been shown in the dotted ellipse in FIG. 4. In this example it has been assumed that the cutting plate 29 has a generally rectangular shape, however with a piece removed from a corner (as illustrated by reference numeral 12 in FIG. 2) in order to produce the desired shape for the first separator layer 5, once the cutting plate penetrates through the separator layer 5. The result is a kind of kiss cutting, where the cutting plate protrudes into the separator 5 and the adhesive release agent. However, this kiss cutting is accomplished without cutting through any other material layers than the first separator layer 5.

The scrap part 46 of the separator layer 5, which has been limited from the anode half cells by the produced cuts, is separated from the anode web and forwarded after the laminator 27 to scrap rewinder 45.

After the laminator 27 the anode web is ready to be used together with a cathode web in order to produce thin batteries. However, in case intermediate storage of the anode web is needed, a new, release liner can be unwound from a release liner unwinder 30 and attached to the anode web to cover the adhesive layer 3 which otherwise would be exposed. After this the anode web with the new release liner can be rewound on the anode rewinder 31.

FIG. 5 illustrates production of a web with cathodes, i.e. with cathode half cells. The apparatus shown in FIG. 5 may be used for producing cathode half cells with the method as explained in connection with FIG. 3 and for use together with the anode web produced with the apparatus explained in connection with FIG. 4.

The second cover layer 2 is unwound from a roll 32 and forwarded to a printing device 33 that applies cathode collector material 9 on a first side 16 of the second cover layer 2. A dryer 34 is employed to speed up the drying of the cathode collector material 9. After drying the cathode collector web is rewound on cathode collector rewinder 47.

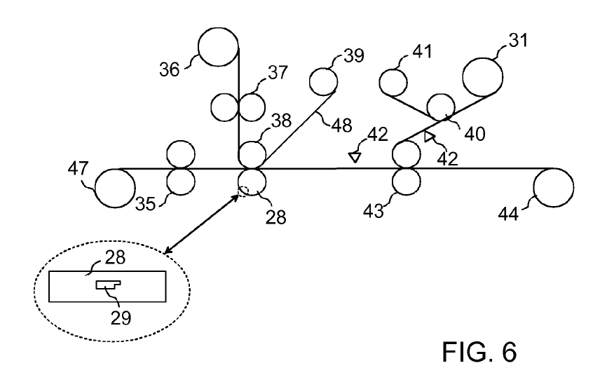

FIG. 6 shows the process for laminating the anode and the cathode collector together i.e. this FIG. 6 shows the last steps in the thin battery production method. After this the web transporting cathode collector is unwound from the rewinder 47 and forwarded to an apparatus 35 which applies the cathode material 8 on the cathode collector material 9 by printing.

The second separator layer 7 is unwound from a second separator unwinder 36 and forwarded to an electrolytic binder printer 37 where the electrolytic binder 6 is printed on the surface 17 of the second separator layer 7.

The second cover layer 2 with the cathode collector material 9 and the cathode material 8, and the second separator 7 with the electrolytic binder 6 are brought together and attached to each other with a die cutter 38. The die cutter 38 also includes a similar roll 28 with a cutting plate 29 as previously explained in connection with FIG. 4. Thus a form of kiss cutting is applied where the second separator layer 7 is provided with cuts in order to delimit a cathode, i.e. a cathode half cell with the cuts. The scrap part 48 of the second separator layer 7 is removed to a roll 39. After this, the cathode web is ready to be connected to the anode web.

In this example the anode web is unwound from roll 31. The web is then forwarded to a guiding roll 40 removing the second release liner to a release liner rewinder 41. This part of the apparatus in FIG. 6 is naturally not necessary in case the anode web is produced simultaneously with the cathode web without any intermediate storing. The anode web and the cathode web are laminated together in laminator 43.

Finally, in FIG. 6 the produced web with thin batteries is rewound on a battery web rewinder 44. In this way an entire roll of thin batteries can, if desired, be delivered to a customer who wants to treat the thin batteries further as a continuous web, for instance, by an apparatus that automatically cuts thin batteries from the web and installs them in a product. Alternatively, instead of rolling up the web on a roll, a cutting device can be employed, that cuts the web between the thin batteries, such that the thin batteries are separated from each other. In this way single, i.e. individual thin batteries are obtained for further actions.

In the explanation above the material of the different layers has been indicated by way of example only, as materials used in the different layers of thin batteries are known from the prior art. Naturally other materials suitable for use in thin batteries can be used instead of the mentioned materials or in addition to the mentioned materials.

In the previous explanations, it has been mentioned that the different webs are aligned to each other to mutual predetermined positions. Such aligning is carried out for:
the first separator layer 5 with the anode material 4 and the first cover layer 1,
the second separator layer 7 with the electrolytic binder 6 and the second cover layer 2 with the cathode collector material 9 and the cathode material 8, and
the anode web and the cathode web.

In all above mentioned aligning processes an automatic detector can be used, which monitors alignment marks or location of areas with particular material on the respective webs. Such automatic detectors, which by way of example have been indicated with reference numerals 42 in FIG. 6, may be optical or ultrasonic detectors, for instance.

It is to be understood that the above description and the accompanying Figures are only intended to illustrate the present invention. It will be obvious to a person skilled in the art that the invention can be varied and modified without departing from the scope of the invention.

What is claimed is:

1. A method of producing thin batteries, said method comprising:
bringing into use an anode web comprising anodes consisting of multiple material layers applied on top of each other, and which layers are mutually aligned and sized for use in a thin battery;
bringing into use a cathode web comprising cathode collectors consisting of multiple material layers applied on top of each other, and which layers are mutually aligned and sized for use in a thin battery;
aligning said anode web and said cathode web into a mutual predetermined position;
bringing said anode web and said cathode web into contact with each other; and
in response to said bringing into contact, attaching said anodes to corresponding cathode collectors for producing thin batteries.

2. The method of claim 1, wherein said bringing into use an anode web further comprises:
applying an adhesive release agent on a first side of a first separator layer, such that said adhesive release agent is not applied on areas reserved for anodes;
applying anode material on said first side of said first separator layer to cover said areas reserved for anodes;
arranging a first cover layer and an adhesive layer on top of said first separator layer in mutual alignment so that said anode material and respectively said adhesive release agent are placed between said cover layer and said first separator layer;
producing cuts through the first separator layer from a second side of said first separator layer, which cuts penetrate through at least said first separator layer but not deeper than to the adhesive layer, for delimiting with said cuts an anode comprising said anode material from a scrap part of the first separator layer; and
removing said scrap part of the first separator layer.

3. The method of claim 2, wherein at least one of said adhesive release agent and said anode material is applied by printing.

4. The method of claim 1, wherein said method comprises cutting terminal holes into said first cover layer.

5. The method of claim 2, wherein said bringing into use an anode web further comprises:
bringing said anode web into contact with a release liner such that the release liner covers said adhesive layer which is located on said first cover layer;
temporarily winding up the anode web on a roll;
subsequently pulling out said anode web from said roll; and
removing said release liner from said adhesive layer located on said first cover layer.

6. The method of claim 1, wherein said bringing into use a cathode web further comprises:
applying a cathode collector material on a first side of a second cover layer on areas reserved for cathodes;
applying a cathode material on said cathode collector material;
applying an electrolyte binder on predetermined electrolyte binder areas of a first side of a second separator layer;
aligning said second cover layer and said second separator layer on top of each other into a mutual predetermined position, wherein said first side of the second cover layer faces a second side of the second separator layer, and the cathode material, which is located in corresponding locations as the electrolyte binder areas, but on the opposite side of the second separator layer as compared to the electrolyte binder areas, attaches said second cover layer and said second separator layer to each other;
producing cuts through the second separator layer from said first side of said second separator layer, which cuts do not penetrate substantially deeper than to the second separator layer, for delimiting a cathode comprising said cathode collector material, said cathode material, said electrolyte binder and said second separator layer between said cathode material and said electrolyte binder; and
removing a scrap part of the second separator layer which is not a part of the cathode delimited by said cuts.

7. The method of claim 6, wherein at least said cathode collector material, said cathode material or said electrolyte binder is applied by printing.

8. The method of claim 6, wherein said electrolyte binder area and the electrolyte binder applied thereon has a surface area smaller than a surface area of the first and second separator layer, respectively.

9. The method of claim 2, wherein said producing of cuts involves use of a plate arranged to protrude a distance from a support, which distance is slightly bigger than the thickness of the material layer where the cuts are produced, and pressing of said plate and support towards the material layer wherein the cuts are produced, until the support contacts said material layer.

10. The method of claim 1, wherein said first and second cover layers and said first and second separator layers are unwound from respective rolls.

11. The method of claim 1, wherein said anode and cathode webs which are attached to each other are rewound on a roll.

12. A thin battery produced according to a method of providing thin batteries, said method comprising:
bringing into use an anode web comprising anodes consisting of multiple material layers applied on top of each other, and which layers are mutually aligned and sized for use in a thin battery;
bringing into use a cathode web comprising cathode collectors consisting of multiple material layers applied on top of each other, and which layers are mutually aligned and sized for use in a thin battery;
aligning said anode web and said cathode web into a mutual predetermined position;
bringing said anode web and said cathode web into contact with each other; and
in response to said bringing into contact, attaching said anodes to corresponding cathode collectors for producing thin batteries.

13. An apparatus for producing a thin battery according to a method of providing thin batteries, said method comprising:
bringing into use an anode web comprising anodes consisting of multiple material layers applied on top of each other, and which layers are mutually aligned and sized for use in a thin battery;
bringing into use a cathode web comprising cathode collectors consisting of multiple material layers applied on top of each other, and which layers are mutually aligned and sized for use in a thin battery;
aligning said anode web and said cathode web into a mutual predetermined position;
bringing said anode web and said cathode web into contact with each other; and
in response to said bringing into contact, attaching said anodes to corresponding cathode collectors for producing thin batteries.
